(19) United States
(12) Patent Application Publication
(10) Pub. No.: US 2011/0265766 A1
(43) Pub. Date: Nov. 3, 2011

(54) FUEL DELIVERY PIPE

(75) Inventors: Kensuke NIWA, Nagoya-shi (JP); Hikaru KIKUTA, Takahama-shi (JP); Yoji TSUZUKI, Nagoya-shi (JP)

(73) Assignee: AISAN KOGYO KABUSHIKI KAISHA, Obu-shi (JP)

(21) Appl. No.: 13/043,945

(22) Filed: Mar. 9, 2011

(30) Foreign Application Priority Data
Apr. 28, 2010 (JP) 2010-103159

(51) Int. Cl. F02M 55/02; F16L 9/00

(52) U.S. Cl. 123/468; 138/177

(57) ABSTRACT

A fuel delivery pipe made of resin, comprises: a pipe body internally formed with a fuel passage; an inlet pipe for introducing fuel into the pipe body; and a plurality of injector attaching parts for distributing the fuel introduced into the pipe body to a plurality of injectors through the fuel passage, the inlet pipe having an internal diameter smaller than an internal diameter of the pipe body and being integrally formed at one end of the pipe body through a joint portion provided with a slant surface with a diameter gradually decreasing toward a root of the inlet pipe.

### CROSS-REFERENCE TO RELATED APPLICATIONS

This application is based upon and claims the benefit of priority from the prior Japanese Patent Application No. 2010-103159, filed Apr. 28, 2011, the entire contents of which are incorporated herein by reference.

### TECHNICAL FIELD

The present invention relates to a fuel delivery pipe for distributing and supplying fuel into injectors in cylinders of an internal combustion engine and, more particularly, to a fuel delivery pipe made of synthetic resin.

### BACKGROUND ART

Heretofore, a fuel delivery pipe has been used to distribute fuel from a fuel tank to injectors provided in cylinders of an internal combustion engine. This fuel delivery pipe includes a pipe body formed with a fuel passage, an inlet pipe for introducing fuel into the pipe body, and a plurality of injector attaching parts for distributing the fuel introduced in the pipe body to the injectors.

For instance, in a fuel delivery pipe disclosed in JP 11(1999)-230002A, an inlet pipe (a fuel inlet pipe) is formed at one end of a pipe body so that the inside of the inlet pipe is communicated linearly with the inside of the pipe body. The inlet pipe is designed to have an internal diameter equal to or larger than an internal diameter of the pipe body, thereby allowing a core mold for forming the interior space of the fuel delivery pipe to be removed from the inside of the inlet pipe. Thus, a fuel delivery pipe integral with the inlet pipe can be manufactured. In this way, a reduced number of components and a reduced manufacturing cost are achieved.

However, in the conventional fuel delivery pipe mentioned above, the internal diameter of the inlet pipe is equal to or larger than that of the pipe body. Such inlet pipe is not connectable directly with a fuel supply hose. Accordingly, a joint for connection with the fuel supply hose is additionally needed. This could not take advantage of the reduction in the number of components resulting from integration of the pipe body with the inlet pipe. Further, the workability of attaching the fuel delivery pipe to the internal combustion engine is also apt to be complicated.

Here, the above problems could be solved if the inlet pipe with a smaller internal diameter than an internal diameter of the pipe body is integrally formed with the pipe body. However, if they are made integrally by simple molding, a flow direction of molding resin may be drastically changed and disturbed (made turbulent) in a joint portion between the inlet pipe and the pipe body. This causes the occurrence of welds in the joint portion and the disturbance of orientation of filler reinforcing material (e.g., reinforcing glass fibers) in the molding resin in a forward region of the joint portion. As a result, strength of the joint portion (a root of the inlet pipe) and strength of the inlet pipe itself are degraded, leading to a possibility that the strength of the inlet pipe could not be sufficiently ensured.

### SUMMARY OF INVENTION

### Technical Problem

The present invention has a purpose to provide a fuel delivery pipe capable of ensuring sufficient strength of an inlet pipe even when the fuel delivery pipe is formed integrally with the inlet pipe.

### Solution to Problem

To achieve the above purpose, one aspect of the invention provides a fuel delivery pipe made of resin, comprising: a pipe body internally formed with a fuel passage; an inlet pipe for introducing fuel into the pipe body; and a plurality of injector attaching parts for distributing the fuel introduced into the pipe body to a plurality of injectors through the fuel passage, the inlet pipe having an internal diameter smaller than an internal diameter of the pipe body and being integrally formed at one end of the pipe body through a joint portion provided with a slant surface with a diameter gradually decreasing toward a root of the inlet pipe.

### BRIEF DESCRIPTION OF DRAWINGS

FIG. 1 is a front view of a schematic configuration of a fuel delivery pipe in a first embodiment;

FIG. 2 is a bottom view of the schematic configuration of the fuel delivery pipe in the first embodiment;

FIG. 3 is a cross-sectional view taken along a line A-A in FIG. 2;

FIG. 4 is a cross-sectional view of a schematic configuration of molds for resin molding;

FIG. 5 is a front view of a schematic configuration of a fuel delivery pipe in a second embodiment;

FIG. 6 is a bottom view of the schematic configuration of the fuel delivery pipe in the second embodiment; and

FIG. 7 is a cross-sectional view taken along a line A-A in FIG. 6.

### DESCRIPTION OF EMBODIMENTS

A detailed description of a preferred embodiment of a fuel delivery pipe embodying the present invention will now be given referring to the accompanying drawings. In this embodiment, the present invention is applied to a fuel delivery pipe for supplying gasoline to a gasoline engine.

### First Embodiment

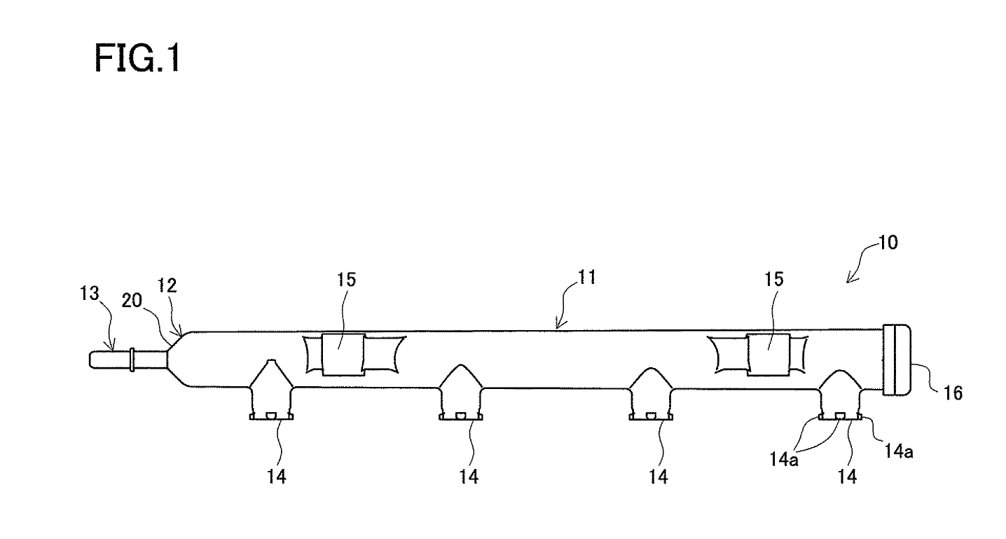

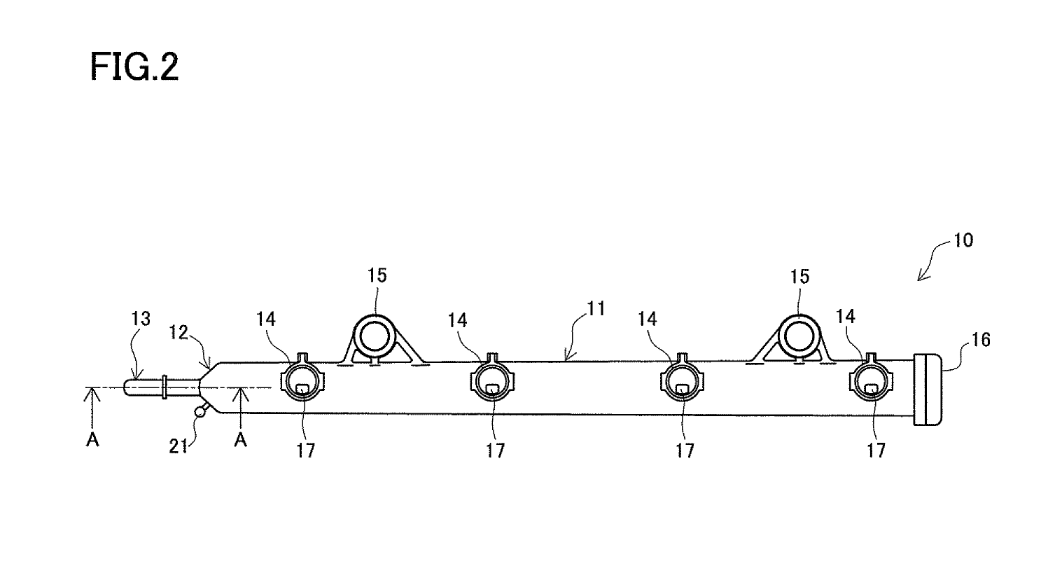

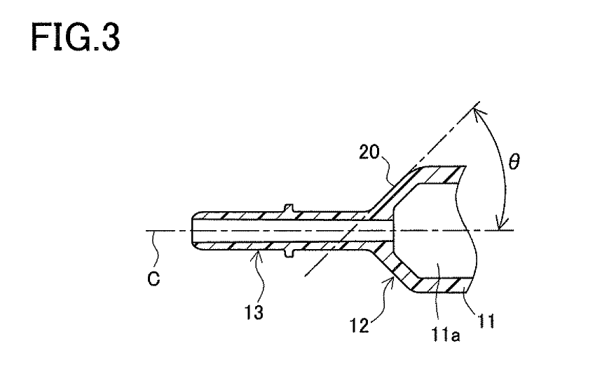

A fuel delivery pipe in the first embodiment will be first explained referring to FIGS. 1 to 3. FIG. 1 is a front view of a schematic configuration of the fuel delivery pipe in the first embodiment. FIG. 2 is a bottom view of the fuel delivery pipe. FIG. 3 is a cross-sectional view of a part of the fuel delivery pipe taken along a line A-A in FIG. 2.

As shown in FIGS. 1 and 2, a fuel delivery pipe 10 includes a pipe body 11 having an almost cylindrical shape, an inlet pipe 13 integrally formed at one end of the pipe body 11 through a joint portion 12, a plurality (four in this embodiment) of injector attaching parts 14 formed to protrude from a lower side of the pipe body 11, and a pair of mounting flanges 15 formed on the pipe body 11 and spaced in the longitudinal direction of the pipe body 11. This fuel delivery pipe 10 is a resin-molded component made of composite resin mixed with a filler reinforcing material consisting of short fibers. In this embodiment, the composite resin is preferably polyamide resin such as 66 nylon and the filler reinforcing material is preferably glass fibers. At the other end of the pipe body 11, a closing cap 16 is welded.

The pipe body 11 is internally formed with a fuel passage 11a as shown in FIG. 3. This passage 11a is communicated with the inlet pipe 13. The inlet pipe 13 has the internal diameter smaller than the internal diameter of the pipe body 11 to enable direct connection with a fuel supply hose. The other end of this hose is to be connected to a fuel pipe leading to a fuel pump. Accordingly, fuel is introduced in the fuel passage 11a of the pipe body 11 through the inlet pipe 13.

The inlet pipe 13 is molded integrally with the pipe body 11 through the joint portion 12. In this embodiment, the inlet pipe 13 is arranged with its central axis coinciding (in alignment) with the central axis of the pipe body 11. The joint portion 12 includes a slant (tapered) surface 20 with a diameter gradually decreasing from a pipe body 11 side to an inlet pipe 13 side. This slant surface 20 is designed so that an angle θ (see FIG. 3) to a central axis C of the inlet pipe 13 meets a relation of θ≦60°. This setting range of the angle θ is determined for the following reason. If the angle θ is larger than 60° (θ>60), the flow of resin is disturbed in the joint portion 12 during resin molding of the fuel delivery pipe 10. This is likely to cause welds in the joint portion 12 and the disturbance of orientation of the filler reinforcing material in the resin forward of the joint portion, that is, in the joint portion 12 and the inlet pipe 13. On the other hand, if the angle θ is smaller, the length of the joint portion 12 is longer, resulting in an increase in size of the fuel delivery pipe 10 (an increase in length in an axial direction). Therefore, the angle θ is preferably determined to meet a relation of 30°≦θ≦60°. In this embodiment, the angle θ is set to 45°.

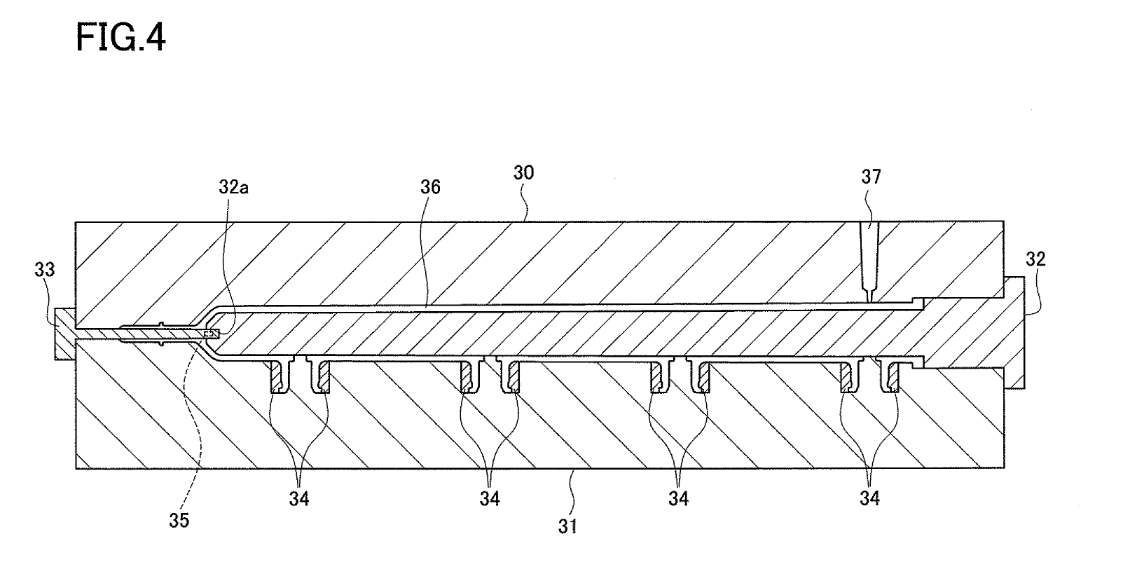

Here, a root portion of the inlet pipe 13 continuous with the joint portion 12, that is, a boundary portion between the inlet pipe 13 and the joint portion 12 is formed thicker than other portions. This is intended to enhance the strength of the root portion of the inlet pipe 13 and further avoid an acute-angled end of a slide mold 32 and also increase the strength of a fitting hole 32a (see FIG. 4).

Each injector attaching part 14 is formed in an almost cylindrical shape branching off from the pipe body 11 and opening downward in FIG. 1. In each injector attaching part 14, an injector is inserted and fixed. The injector attaching parts 14 are communicated with the fuel passage 11a through respective communication passages 17. Accordingly, the injector attaching parts 14 are able to distribute fuel introduced in the fuel passage 11a of the pipe body 11 to respective injectors.

The mounting flanges 15 are used to fix the fuel delivery pipe 10 to an engine with bolts or the like. The pipe 10 is fixed, with the injector attaching parts 14 facing down, to the engine through the flanges 15 as shown in FIG. 1.

The aforementioned fuel delivery pipe 10 is molded of resin in the following manner. As shown in FIG. 4, firstly, an upper mold 30 and a lower mold 31 are combined to form a space for molding the pipe 10. Successively, slide molds (cores) 32, 33, and 34 are inserted and set in this space. In the molds, accordingly, a cavity 36 is formed for molding the fuel delivery pipe 10. FIG. 4 is a cross-sectional view of a schematic configuration of the molds for resin molding.

Herein, the slide mold 32 is used to form the pipe body 11 (the fuel passage Ha) and the joint portion 12 and is inserted in the above space from the right side in FIG. 4. This slide mold 32 includes a tapered distal end (a left end in FIG. 4) to form, in combination with the upper mold 30 and the lower mold 31, the slant surface 20 in the joint portion 12. The slide mold 32 is formed, at the center of the distal end, with the fitting hole 32a in which a distal end (a right end in FIG. 4) of the slide mold 33 is fitted.

The slide mold 33 is used to form the inlet pipe 13 and is inserted in the above space from the left side in FIG. 4. At that time, the distal end of the slide mold 33 is fitted in the fitting hole 32a of the slide mold 32. The slide molds 32 and 33 are thus integrally connected. An overflow gate 35 is provided in the molds 30, 31 in this embodiment near the distal end of the slide mold 33 and on a far side of the drawing sheet.

The slide molds 34 are used to form protrusions 14a around the end of each injector attaching part 14 and are inserted in the above space from a near side to the far side of the drawing sheet of FIG. 4.

When the molds 30 to 34 are completely set as shown in FIG. 4, composite resin mixed with the filler reinforcing material is injected into the cavity 36 defined by the molds through a molding gate 37 formed in the upper mold 30. Thus, insert molding is performed. The molding gate 37 is located in the mold 30 corresponding to a right end portion of the pipe body 11. Accordingly, the composite resin is injected from the right end of the fuel delivery pipe 10 and hence caused to flow from the right end in a longitudinal direction of the pipe 10, so that the composite resin is filled sequentially from the right end to the left end. In other words, the composite resin is sequentially filled from the right end portion of the pipe body 11 to the inlet pipe 13.

Since the joint portion 12 includes the slant surface 20, the composite resin is also allowed to smoothly flow in the joint portion 12. Consequently, welds are unlikely to occur in the joint portion 12 and the root of the inlet pipe 13 and the orientation of the filler reinforcing material in the joint portion 12 and the inlet pipe 13 are prevented from disturbing. As described above, the inlet pipe 13 is formed thicker in the root portion than in other portions. This configuration can prevent both a decrease in strength of the joint portion 12 and the root of the inlet pipe 13 and a decrease in strength of the inlet pipe 13 itself. As a result, the fuel delivery pipe 10 integral with the inlet pipe 13 having sufficient strength can be provided.

Gas occurs in the process of molding of the fuel delivery pipe 10. If gas burns are generated, the resin surface may be warped or broken. The “gas burns” means a mark of local thermal cracking (heat decomposition) resulting from discoloration of the resin which may turn black due to the generated gas. Since the resin is injected and filled from the right end portion of the pipe body 11 (an opposite end portion to the inlet pipe 13), the gas occurring during molding is compressed in a resin flowing end and thus increased to a high temperature, which is likely to affect the molding of the inlet pipe 13. For instance, if the gas burns occur in a portion of the inlet pipe 13 in the process of resin molding, molding defects occurs, e.g., the surface of the inlet pipe 13 gets rough. Accordingly, lack of strength, sealing failure, or other failures may be caused.

In contrast, since the overflow gate 35 is provided in the molds, an overflow-resin accumulated portion 21 is formed of excessive resin in the joint portion 12 (see FIG. 2). This can prevent the gas occurring during molding from flowing in the inlet pipe 13. It is therefore possible to prevent molding failures of the inlet pipe 13 and provide sufficient strength thereof. The overflow-resin accumulated portion 21 may be removed after resin molding.

Thereafter, to the fuel delivery pipe 10 resin-molded as above and removed from the molds, the closing cap 16 is attached. Thus, the fuel delivery pipe 10 shown in FIGS. 1 and 2 is completed.

According to the fuel delivery pipe 10 in the first embodiment explained in detail above, the joint portion 12 connecting the pipe body 11 and the inlet pipe 13 includes the slant (tapered) surface 20, so that the composite resin is allowed to flow smoothly even in the joint portion 12. This can prevent the occurrence of welds in the joint portion 12 and the root of the inlet pipe 13 and also suppress the disturbance of orientation of the filler reinforcing material in the joint portion 12 and the inlet pipe 13. In the fuel delivery pipe 10 integrally formed with the inlet pipe 13, consequently, sufficient strength of the inlet pipe 13 can be ensured.

Further, since the overflow-resin accumulated portion 21 is formed in the joint portion 12, the gas occurring during molding is less likely to flow in the inlet pipe 13. This also contributes to ensuring the strength of the inlet pipe 13.

### Second Embodiment

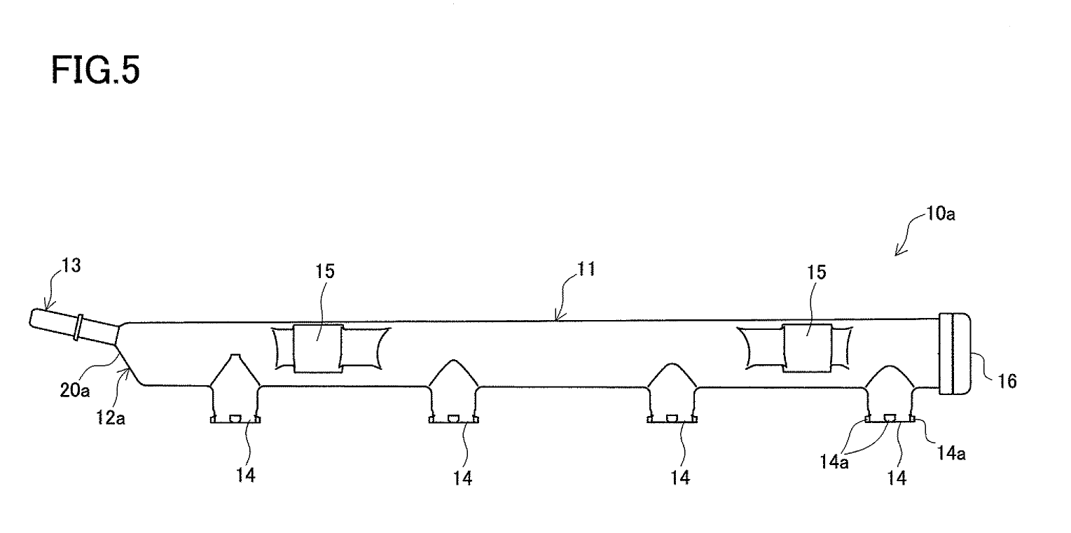

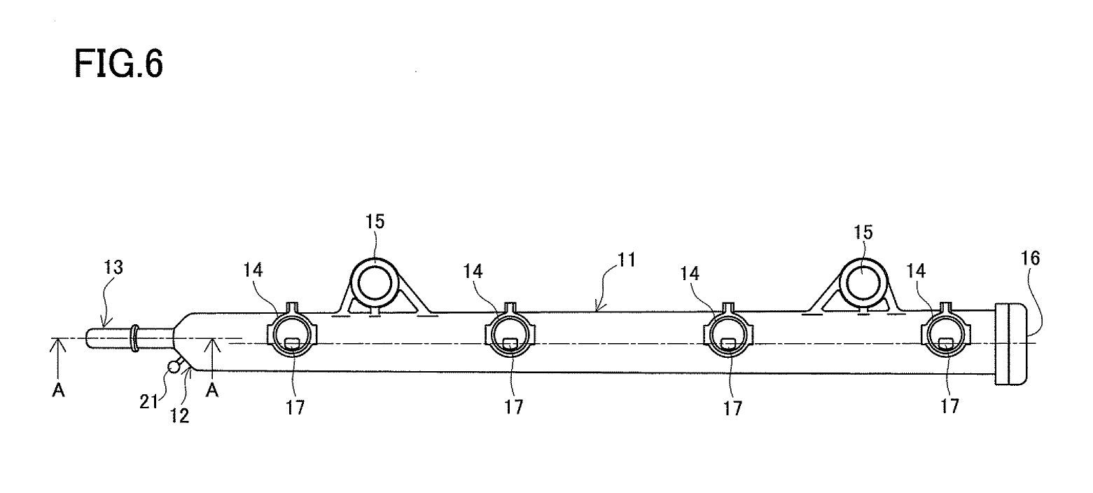

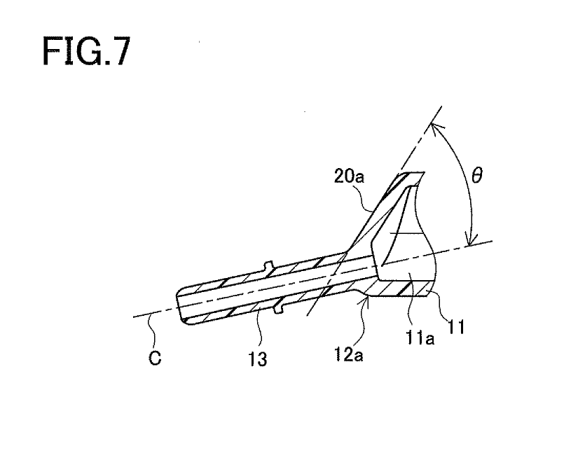

A second embodiment of the invention will be explained below. The second embodiment is basically identical in structure to the first embodiment, excepting the shape of a joint portion and the placement of an inlet pipe. In the following explanation, similar or identical parts to those in the first embodiment are given the same reference signs as those in the first embodiment and their details are appropriately omitted. The following explanation is therefore made with a focus on differences from the first embodiment. A fuel delivery pipe in the second embodiment is described referring to FIGS. 5 to 7. FIG. 5 is a front view of a schematic configuration of the fuel delivery pipe in the second embodiment. FIG. 6 is a bottom view of the schematic configuration of the fuel delivery pipe. FIG. 7 is a cross-sectional view of the pipe taken along a line A-A in FIG. 6.

As shown in FIGS. 5 and 6, a fuel delivery pipe 10a also includes a pipe body 11, an inlet pipe 13 integrally formed at one end of the pipe body 11 through a joint portion 12a, a plurality (four in this embodiment) of injector attaching parts 14 formed to protrude from a lower side of the pipe body 11, and a pair of mounting flanges 15 formed on the pipe body 11 and spaced in the longitudinal direction of the pipe body 11. The fuel delivery pipe 10a is fixed, with the injector attaching parts 14 facing down, to an engine through the flanges 15 as shown in FIG. 5.

The inlet pipe 13 is placed obliquely with respect to the pipe body 11 so that a leading end of the pipe 13 is oriented opposite the injector attaching parts 14 as shown in FIG. 5. Specifically, the inlet pipe 13 is located in a slanting position with respect to the pipe body 11 so that the leading end of the inlet pipe 13 faces upward when the fuel delivery pipe 10a is mounted on an engine. Accordingly, the fuel staying in the pipe body 11 does not spill out through the inlet pipe 13 in the course of removing the fuel delivery pipe 10a from the engine. Further, the fuel delivery pipe 10a integrally formed with the inlet pipe 13 enables an easy mounting work to the engine. Therefore the fuel delivery pipe 10a can achieve very excellent workability in a mounting and demounting work with respect to the engine.

The root of the inlet pipe 13 is placed off the central longitudinal axis of the pipe body 11 and an opposite side from an overflow-resin accumulated portion 21 relative to the axis as shown in FIG. 6. The inlet pipe 13 is communicated with a fuel passage 11a of the pipe body 11 as shown in FIG. 7. In this embodiment, a slant surface 20a of the joint portion 12a is also oblique at an angle θ=45° with the central axis C of the inlet pipe 13. The root portion of the inlet pipe 13, i.e., a boundary portion between the inlet pipe 13 and the joint portion 12a, is formed thicker than other portions.

Such fuel delivery pipe 10a is also produced in such an insert-molding method as mentioned in the first embodiment. In the fuel delivery pipe 10a, the joint portion 12a is provided with the slant surface 20a and the root of the inlet pipe 13 is placed off the central longitudinal axis of the pipe body 11 and on an opposite side from the overflow resin accumulated portion 21. Accordingly, during resin molding, the composite resin is allowed to smoothly flow even in the joint portion 12a and thus easily flow in the inlet pipe 13. Further, the gas occurring during molding is likely to flow in the overflow resin accumulated portion 21 by the overflow gate 35.

As a result, welds are unlikely to occur in the joint portion 12a and the root of the inlet pipe 13. Further, it is possible to suppress the disturbance of orientation of the filler reinforcing material in the joint portion 12a and the inlet pipe 13 and reliably prevent the gas from getting mixed in the material forming the inlet pipe 13. The root portion of the inlet pipe 13 is formed thicker than other portions as mentioned above. With the above configurations, it is possible to prevent the decrease in strength of the joint portion 12a and the root of the inlet pipe 13 and also the decrease in strength of the inlet pipe 13 itself. Accordingly, the fuel delivery pipe 10a integral with the inlet pipe 13 having sufficient strength can be achieved.

According to the fuel delivery pipe 10a in the second embodiment explained in detail above, the joint portion 12a connecting the pipe body 11 and the inlet pipe 13 is provided with the slant surface 20a. Further, the root of the inlet pipe 13 is placed off the central longitudinal axis of the pipe body 11, opposite from the overflow resin accumulated portion 21. These configurations allow the composite resin to smoothly flow even in the joint portion 12a and easily flow in the inlet pipe 13 and also the gas to easily flow in the overflow resin accumulated portion 21 by the overflow gate 35. Consequently, welds are unlikely to occur in the joint portion 12a and the root of the inlet pipe 13. Further, it is possible to suppress the disturbance of orientation of the filler reinforcing material in the joint portion 12a and the inlet pipe 13 and reliably prevent the gas from getting mixed in the inlet pipe 13. In the fuel delivery pipe 10a integrally formed with the inlet pipe 13, consequently, sufficient strength of the inlet pipe 13 can ensured.

The above embodiments are mere examples and do not limit the scope of the invention. The invention may be embodied in other specific forms without departing from the essential characteristics thereof. For instance, each of the above embodiments includes four injector attaching parts 14 and two mounting flanges 15. The number of injector attaching parts and the number of flanges may be increased or decreased appropriately according to the specification of an engine.

The above embodiments exemplify the fuel delivery pipe embodying the invention for use in a gasoline engine. As an alternative, the invention may be applied to a fuel delivery pipe for use in any engine (e.g., an engine driven by liquefied gas fuels) other than the gasoline engine, and a fuel delivery pipe for use in a bi-fuel engine.

1. A fuel delivery pipe made of resin, comprising:
a pipe body internally formed with a fuel passage;
an inlet pipe for introducing fuel into the pipe body; and
a plurality of injector attaching parts for distributing the fuel introduced into the pipe body to a plurality of injectors through the fuel passage,
the inlet pipe having an internal diameter smaller than an internal diameter of the pipe body and being integrally formed at one end of the pipe body through a joint portion provided with a slant surface with a diameter gradually decreasing toward a root of the inlet pipe.

2. The fuel delivery pipe according to claim 1, wherein the slant surface is formed at an angle of 60° or less with respect to a central axis of the inlet pipe.

3. The fuel delivery pipe according to claim 2, wherein the slant surface is formed at an angle of 30° or more and 60° or less with respect to the central axis of the inlet pipe.

4. The fuel delivery pipe according to claim 1, wherein the joint portion is 2 0 formed with an overflow-resin accumulated portion formed of excess resin.

5. The fuel delivery pipe according to claim 4, wherein the root of the inlet pipe is placed off the central longitudinal axis of the pipe body and on an opposite side from the overflow-resin accumulated portion relative to the axis.

6. The fuel delivery pipe according to claim 1, wherein the inlet pipe is placed obliquely to the pipe body so that a leading end of the inlet pipe faces upward when the fuel delivery pipe is mounted on an internal combustion engine.

7. The fuel delivery pipe according to claim 1, wherein the inlet pipe is placed obliquely to the pipe body so that a leading end of the inlet pipe is oriented opposite the injector attaching parts.

8. The fuel delivery pipe according to claim 1, wherein a boundary portion between the inlet pipe and the joint portion is formed thicker than other portions.

9. The fuel delivery pipe according to claim 1, wherein the internal diameter of the inlet pipe is smaller than the internal diameter of the pipe body.
